(19) United States
(12) Patent Application Publication
(10) Pub. No.: US 2026/0258761 A1
(43) Pub. Date: Sep. 3, 2026

(54) Operation Condition Calculation System, Control Device for Internal Combustion Engine, and Adaptation Device for Internal Combustion Engine

(71) Applicant: Astemo, Ltd., Chiyoda-ku, Tokyo (JP)

(72) Inventors: Kenta MITSUFUJI, Tokyo (JP); Kunihiko SUZUKI, Hitachinaka-shi, Ibaraki (JP); Ryo KUSAKABE, Hitachinaka-shi, Ibaraki (JP); Tomoyuki HOSAKA, Tokyo (JP)

(21) Appl. No.: 19/162,983

(22) PCT Filed: Jun. 10, 2024
(86) PCT No.: PCT/JP2024/021098

§ 371 Date: Sep. 8, 2025

(30) Foreign Application Priority Data
Jun. 21, 2023 (JP) 2023-101634

(51) Int. Cl. F02D 41/02; F02D 41/40; F02P 5/15; G05B 13/02; G07C 5/08

(52) U.S. Cl. CPC F02D 41/021; F02D 41/401; F02P 5/1502; G05B 13/0265; G07C 5/0808; G07C 5/0825; F02D 2200/702

(57) ABSTRACT

An operation condition calculation system includes: a first learning device which inputs an operation condition of an on-vehicle device mounted on a vehicle and outputs a physical state which occurs when the on-vehicle device operates based on the operation condition; a second learning device which inputs an output of the first learning device and outputs a performance index; a gradient calculation unit which calculates gradients of the first learning device and the second learning device; and an operation changing unit which changes the operation condition using the gradients.

### TECHNICAL FIELD

The present invention relates to an operation condition calculation system, a control device for an internal combustion engine, and an adaptation device for the internal combustion engine.

### BACKGROUND ART

In recent years, there has been a problem in reducing emissions of PN (Particulate Number) and THC (Total Hydro Carbon) which occur upon starting an engine or at low-temperature driving as the development of an environmentally friendly engine progresses. These occur particularly frequently under conditions where the external atmosphere is low in temperature or when the engine is started, and suppression of these is required. Further, it is necessary to predict their occurrence in advance by real-time control and adjust operation conditions. Patent Literature 1 discloses a method for monitoring an engine using a cascaded neural network including a plurality of neural networks, which includes the steps of storing data corresponding to the cascaded neural network in a memory, inputting signals generated by a plurality of engine sensors to the cascaded neural network, and updating a second neural network with the output of a first neural network at a first speed, and includes a step in which the output is based on the input signal, and a step of outputting at least one engine control signal from the second neural network at a second speed, and in which the second speed is faster than the first speed.

### CITATION LIST

### Patent Literature

Patent Literature 1: Japanese Unexamined Patent Application Publication No. 2003-328837

### SUMMARY OF INVENTION

### Technical Problem

The invention described in Patent Literature 1 leaves room for improvement in the setting of the operation condition.

### Solution to Problem

An operation condition calculation system according to a first aspect of the present invention includes: a first learning device which inputs an operation condition of an on-vehicle device mounted on a vehicle and outputs a physical state which occurs when the on-vehicle device operates based on the operation condition; a second learning device which inputs an output of the first learning device and outputs a performance index; a gradient calculation unit which calculates gradients of the first learning device and the second learning device; and an operation changing unit which changes the operation condition using the gradients.

A control device for an internal combustion engine according to a second aspect of the present invention is equipped with the operation condition calculation system described above.

An adaptation device for an internal combustion engine according to a third aspect of the present invention is equipped with the operation condition calculation system described above.

### Advantageous Effects of Invention

According to the present invention, it is possible to calculate a favorable operation condition from the viewpoint of a performance index.

### BRIEF DESCRIPTION OF DRAWINGS

FIG. 1 is a schematic diagram of an internal combustion engine;

FIG. 2 is a diagram showing an example of a malfunction in the internal combustion engine;

FIG. 3 is a functional configuration diagram of a computing device according to a first embodiment;

FIG. 4 is a hardware configuration diagram of the computing device;

FIG. 5 is a flowchart showing processing of the computing device;

FIG. 6 is a functional configuration diagram of a computing device according to a modification 1;

FIG. 7 is a functional configuration diagram of a computing device according to a second embodiment;

FIG. 8 is a functional configuration diagram of a computing device according to a third embodiment;

FIG. 9 is a functional configuration diagram of a computing device according to a fourth embodiment;

FIG. 10 is a functional configuration diagram of a computing device according to a fifth embodiment;

FIG. 11 is a functional configuration diagram of a computing device according to a sixth embodiment;

### DESCRIPTION OF EMBODIMENTS

### First Embodiment

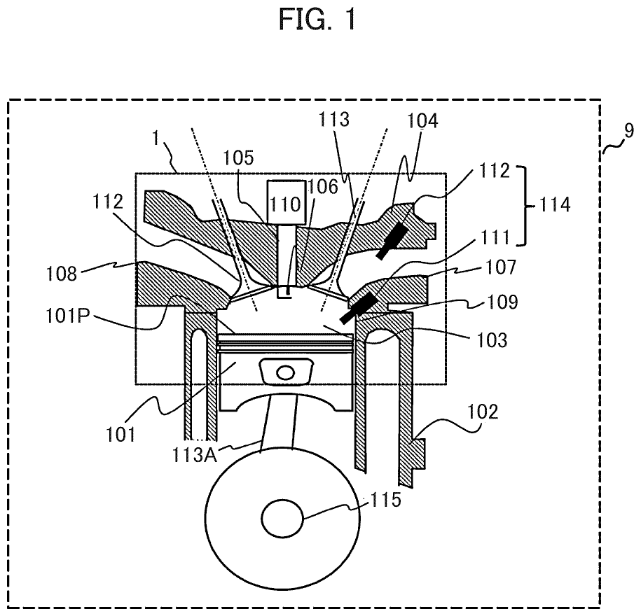

Hereinafter, a first embodiment of an operation condition calculation system will be described with reference to FIGS. 1 to 5.

FIG. 1 is a schematic diagram of an internal combustion engine 1 which is the subject of calculations by an operation condition calculation system. The internal combustion engine 1 mounted on a vehicle 9 includes a piston 101, a cylinder 102, and a cylinder head 104. The cylinder head 104 forms a combustion chamber 103 by a piston crown surface 101P of the piston 101 and a combustion chamber inner wall 109 of the cylinder 102. The internal combustion engine 1 also includes at least one of a direct injection injector 111 and a port injection injector 112 as a fuel injection injector.

An ignition plug 105 having an electrode 106 which ignites an air-fuel mixture is placed directly above the combustion chamber 103. During an intake stroke, air flows into the combustion chamber 103 through an intake port 107 with an intake valve 113 open, which communicates with a main combustion chamber. Fuel is sent to the combustion chamber 103 by being sprayed in a mist form from the direct injection injector 111 or the port injection injector 112, where it vaporizes and becomes an air-fuel mixture. The mixture is then compressed by the piston 101, and a main ignition signal is sent to an ignition coil 110 at an appropriate timing, thereby causing the ignition plug 105 to ignite the air-fuel mixture in the combustion chamber 103 and burn the mixture in the combustion chamber 103. Thus, the pressure in the combustion chamber 103 rises, thereby pushing down the piston 101, and a connecting rod 113A rotates a crankshaft 115 to obtain power.

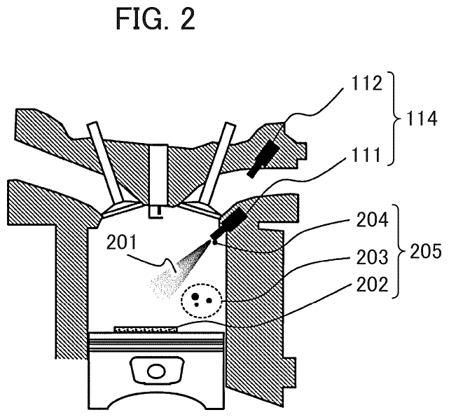

FIG. 2 is a diagram showing an example of a malfunction in the internal combustion engine 1. When injecting liquid fuel from the injector, the fuel in the liquid state may adhere to an opposing wall in the liquid state. For example, as shown in FIG. 2, when a spray 201 is injected into the combustion chamber 103 by the port injection injector 112, a fuel liquid film 202 is formed on the piston crown surface 101P, the combustion chamber inner wall 109, etc. Further, since the spray 201 is high-speed, the impact when it collides with the piston crown surface 101P, the combustion chamber inner wall 109, etc. may cause droplets 203 to fly out into the combustion chamber 103. In addition, there may occur tip wet 204 in which droplets of fuel remain and adhere around the injection port of the direct injection injector 111.

If the fuel liquid film 202 or droplets 203 remains when the mixture in the combustion chamber 103 is ignited by use of the ignition plug 105, they will burn in a liquid state. At this time, the fuel liquid film 202, droplets 203, and tip wet 204 remaining at the moment the flame arrives will diffuse and burn without being able to contribute to the output of the engine. As a result, PN (Particulate Number) and THC (Total Hydro Carbon) are generated. The same problem occurs even when the port injection injector 112 is used. The fuel which is not able to contribute to the engine output such as the fuel liquid film 202, droplets 203, and tip wet 204 is called unburned fuel 205. Further, if the generation of the unburned fuel 205 reduces the fuel concentration of the mixture in the combustion chamber 103, and the fuel existing around the ignition plug 105 becomes insufficient, there occur problems such as the flame not growing sufficiently when ignited by the ignition plug 105 to cause misfires, or unstable combustion.

In addition, under cold engine conditions represented by low-temperature start-up, not only is unburned fuel 205 more likely to occur, but there are also the following problems.

That is, since the temperature inside the combustion chamber 103 is also often low, there is concern that the number of misfires increases, and a large amount of PN and THC will be generated, so that combustion stability is deteriorated.

Furthermore, during the operation of the internal combustion engine, the internal state of the combustion chamber 103 including the amount of the unburned fuel 205 is intricately related to external factors such as the flow inside the cylinder, an outside air temperature, a cooling water temperature, and a fuel temperature, and many factors such as control variables such as an engine speed, a fuel injection timing, a fuel injection division number, and an ignition timing. In addition, since the amounts of PN and THC generated are determined through complex physical phenomena such as combustion and chemical reactions, it is not easy to predict the amounts of generated PN and THC from the operation conditions, etc.

In contrast, there have been proposed several technologies in which final exhaust components are predicted from operation conditions or the like by using machine learning or the like represented by neural networks. However, as described above, the accuracy of prediction is reduced due to the fact that there are too many operation conditions on which learning is based, and conditions unrelated to the final output are also input, thereby resulting in noise, and others. Therefore, in the present embodiment, paying attention to the fact that the exhaust components from the internal combustion engine 1 and the combustibility within the internal combustion engine 1 are highly dependent on the state of the mixture ignited by the ignition plug 105 in the combustion chamber 103, the favorable operation conditions are calculated from the viewpoint of the performance index as will be described below.

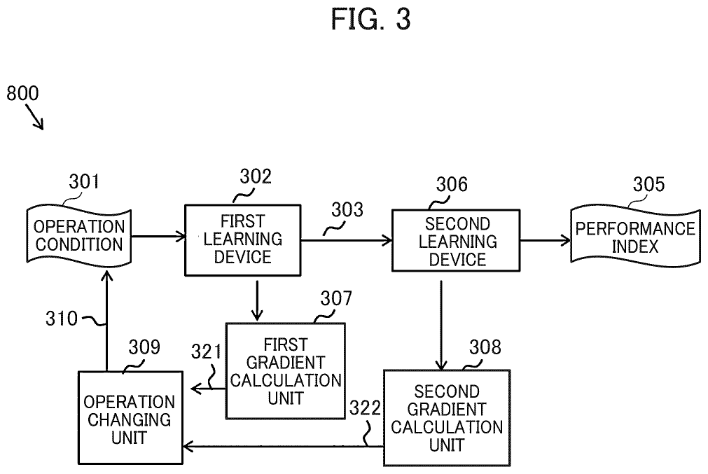

FIG. 3 is a functional configuration diagram of a computing device 800. The computing device 800 is a general-purpose computer or an electronic control device. The computing device 800 may or may not be mounted on the vehicle 9 having the internal combustion engine 1. When the computing device 800 is mounted on the vehicle 9, the internal combustion engine 1 can be controlled using calculation results of the computing device 800. In this case, the computing device 800 can be called a “control device” of the internal combustion engine 1. When the computing device 800 is not mounted on the vehicle 9, the optimal control conditions according to the design specifications of the internal combustion engine 1 are determined, for example, in the design stage of the internal combustion engine 1. In this case, the computing device 800 is also called an “adaptation device” of the internal combustion engine 1. The computing device 800 includes a first learning device 302, a second learning device 306, a first gradient calculation unit 307, a second gradient calculation unit 308, and an operation changing unit 309.

The first leaning device 302 is a learning device which has been previously trained. The input of the first learning device 302 is an operation condition 301 of the internal combustion engine 1, and the output of the first learning device 302 is a physical quantity 303 which indicates an internal state of the combustion chamber 103 at the time of ignition. The second learning device 306 is a learning device which has been previously trained. The input of the second learning device 306 is the physical quantity 303 which indicates the internal state of the combustion chamber 103 at the time of ignition, and the output of the second learning device 306 is a performance index 305. However, although not shown in FIG. 3, a part or all of the operation condition 301 may be input to the second learning device 306. Data used for learning of the first learning device 302 and the second learning device 306 may be data obtained by numerical analysis or may be actual measured values. The operation condition 301 is data actually acquired from a sensor mounted on the vehicle 9, or data which can be acquired from the sensor mounted on the vehicle 9.

The operation condition 301 includes specific conditions which are a plurality of detailed operation conditions. The specific conditions are an intake air temperature, a cooling water temperature, a load, the number of fuel injections, a rotation speed, an injection amount for each injection, an injection start time, an injection duration, fuel pressure, an ignition timing, etc. The specific conditions may further include the number of divisions at the time of split fuel injection of the fuel, an injection time, an injection duration, and an injection split ratio. Incidentally, the specific conditions include conditions which cannot be easily changed by the internal combustion engine 1, such as the outside air temperature (hereinafter also referred to as “external factors”), and conditions related to the control of the internal combustion engine 1 (hereinafter also referred to as “control variables”). The external factors are the outside air temperature, the cooling water temperature, and the load, etc. The control variables are the number of fuel injections, the injection amount for each injection, the injection start time, the injection duration, the fuel pressure, the ignition timing, etc. Various combinations are possible for the operation condition 301, but for example, a rotation speed, a load, intake pressure, an intake air temperature, a water temperature, fuel pressure, the number of fuel injections, a fuel injection timing, a split ratio, and an ignition time may be essential components.

The physical quantity 303 includes specific physical quantities which are a plurality of specific physical quantities. The specific physical quantities are, for example, the amount of mixture, the temperature in the combustion chamber at the time of ignition, and the pressure in the combustion chamber at the time of ignition. Various combinations are possible for the physical quantity 303, but the temperature in the cylinder, the pressure in the cylinder, the amount of attached fuel, and the amount of over-rich mixture at the time of ignition may be essential components.

The performance index 305 includes specific indexes which are one or more specific indexes. The specific indexes are, for example, the amount of PN generated, the amount of THC generated, and a combustion fluctuation rate, etc. The specific indexes may also include indexes which indicate the occurrence of some malfunction in the internal combustion engine, such as an exhaust temperature and a catalyst temperature. Incidentally, the occurrence of PN is strongly influenced by at least the amount of unburned fuel 205 represented by fuel adhesion and floating droplets or the like generated in the combustion chamber, the amount of a rich fuel mixture, and the temperature and pressure in the combustion chamber at the time of ignition. THC is strongly influenced by the fuel that could not be burned and the temperature of the combustion chamber 103, and the combustion fluctuation rate is influenced by fuel richness in the vicinity of the electrode 106 of the ignition plug 105, the pressure and temperature of the combustion chamber 103, and the homogeneity of the mixture in the combustion chamber 103.

The neural network which constitutes the first learning device 302 has the same number of nodes in an input layer as the specific conditions, and has the same number of nodes in an output layer as the specific physical quantities. The neural network which constitutes the second learning device 306 has the same number of nodes in an input layer as the specific physical quantities, and has the same number of nodes in an output layer as the specific indexes.

Incidentally, for example, it is also possible to create a single learning device which inputs the operation condition 301 and outputs the performance index 305. However, the size of each learning device can be reduced by combining the first learning device 302 and the second learning device 306.

Further, it is possible to reduce the number of calculations in the learning device required to estimate the performance index 305, and to achieve an improvement in the estimation accuracy.

The first gradient calculation unit 307 calculates the relationship between the input and output in the first learning device 302 as a first gradient 321. Specifically, the first gradient calculation unit 307 outputs a control variable having the maximum gradient for each of the specific physical quantities being the output of the first learning device 302, and the value of its gradient. The second gradient calculation unit 308 calculates the relationship between the input and output in the second learning device 306 as a second gradient 322. Specifically, the second gradient calculation unit 308 outputs a specific physical quantity having the maximum gradient for each of the performance indexes being the output of the second learning device 306, and the value of its gradient. Therefore, the operation changing unit 309 can acquire the degree of influence of the physical quantity 303 on each performance index 305 and the degree of influence of the operation condition 301 on each physical quantity 303 as gradient values.

The operation changing unit 309 inputs the operation condition 301, the first gradient 321, and the second gradient 322 and outputs a new operation condition 310. However, the new operation condition 310 has a different name and a different symbol simply to distinguish from the initially loaded operation condition 301, and the first learning device 302 loads the new operation condition 310 in a manner similar to the operation condition 301. In calculating the new operation condition 310, the operation changing unit 309 utilizes, for example, the Newton method or the like using a gradient vector obtained from the first gradient calculation When the performance index 305 includes a plurality of indexes, the operation changing unit 309 may specify in advance the index to be improved, or may determine a priority order. The operation changing unit 309 calculates a new operation condition 310 in which the control variable is changed so as to improve the performance index 305. For example, the new operation condition 310 increases the injection time from the current “100 ms” by “10 ms” to be “110 ms”.

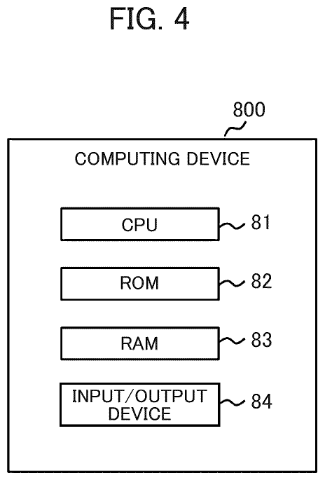

FIG. 4 is a hardware configuration diagram of the computing device 800. The computing device 800 includes a CPU 81 which is a central processing unit, a ROM 82 which is a read-only memory, a RAM 83 which is a random access memory, and an input/output device 84 which is a user interface. The CPU 81 develops a program stored in the ROM 82 to the RAM 83 and executes the same to perform various calculations for the first learning device 302, the operation changing unit 309, etc. The computing device 800 may be realized by an FPGA (Field Programmable Gate Array) being a rewritable logic circuit or an ASIC (Application Specific Integrated Circuit) being an integrated circuit for specific use instead of the combination of the CPU 81, the ROM 82, and the RAM 83. The computing device 800 may also be realized by a combination of different configurations, e.g., a combination of the CPU 81, the ROM 82, RAM 83, and the FPGA instead of the combination of the CPU 81, the ROM 82, and the RAM 83.

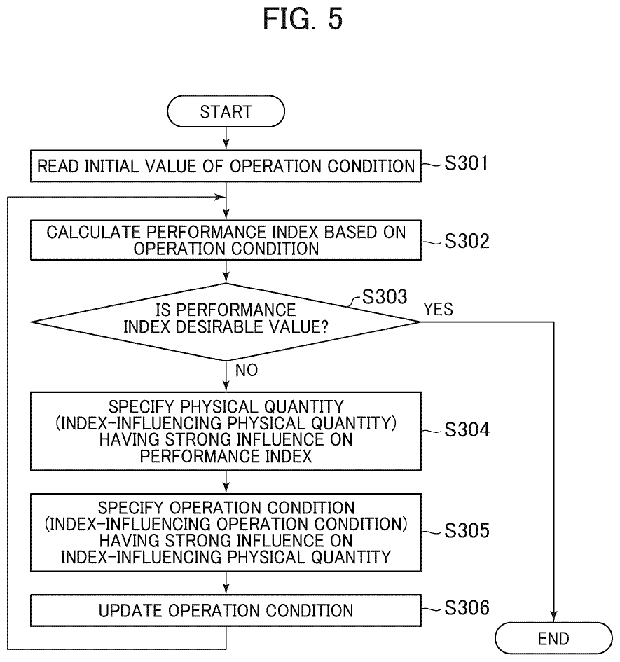

FIG. 5 is a flowchart showing the processing of the computing device 800. In Step S301, the first learning device 302 reads the initial value of the operation condition 301. In the following Step S302, the first learning device 302 and the second learning device 306 calculate the performance index 305 based on the operation condition 301. Specifically, the first learning device 302 calculates the physical quantity 303 based on the operation condition 301, and the second learning device 306 calculates the performance index 305 based on the physical quantity 303.

In the following Step S303, the operation changing unit 309 determines whether or not the performance index 305 calculated in Step S302 is a preferable value. The operation changing unit 309 makes the determination in the present Step, for example, by comparing a predetermined threshold value with the performance index 305. When the operation changing unit 309 determines that the performance index 305 is the preferable value, the processing shown in FIG. 5 is ended.

When it is determined that the performance index 305 is not the preferable value, the process proceeds to Step S304.

In Step S304, the second gradient calculation unit 308 specifies an index-influencing physical quantity which is a physical quantity having a strong influence on the performance index 305. In Step S305, the first gradient calculation unit 307 specifies an index-influencing operation condition which is an operation condition having a strong influence on the index-influencing physical quantity. In the following Step S306, the operation changing unit 309 updates the operation condition 301 and returns to Step S302. Note that when returning from Step S306 to Step S302, the operation condition 301 updated in Step S306 is used in Step S302.

According to the above-described first embodiment, the following actions and effect can be obtained.

(1) The computing device 800 which can also be called an operation condition calculation system includes the first learning device 302 which inputs the operation condition 301 of the internal combustion engine 1 being the on-vehicle device as input, and outputs the physical quantity 303 indicating the physical state generated by the internal combustion engine 1 based on the operation condition 301, the second learning device 306 which inputs the output of the first learning device 302 and outputs the performance index 305, the first gradient calculation unit 307 and the second gradient calculation unit 308 which are the gradient calculation units calculating the gradients of the first learning device 302 and the second learning device 306, and the operation changing unit 309 which changes the operation condition 301 using the first gradient 321 and the second gradient 322. Therefore, it is possible to calculate the favorable operation condition 301 from the viewpoint of the performance index 305.

(2) The performance index 305 is at least one of the exhaust components from the internal combustion engine 1 and the combustion fluctuation rate. The operation changing unit 309 changes at least one of the injection time, the injection split ratio, the fuel pressure, and the ignition timing at the time of the split injection of the fuel.

(3) The first learning device 302 inputs at least the rotation, the load, the intake pressure, the intake air temperature, the water temperature, the fuel pressure, the number of fuel injections, the fuel injection timing, the split ratio, and the ignition time, and outputs at least the in-cylinder temperature, the in-cylinder pressure, the amount of fuel attached, and the amount of over-rich mixture at the ignition time.

(4) The second learning device 306 inputs at least the in-cylinder temperature, the in-cylinder pressure, the amount of fuel attached, the amount of over-rich mixture, and some or all of the input to the first learning device immediately before ignition. The second learning device 306 outputs at least the exhaust components generated after combustion and the combustion fluctuation rate.

### Modification 1

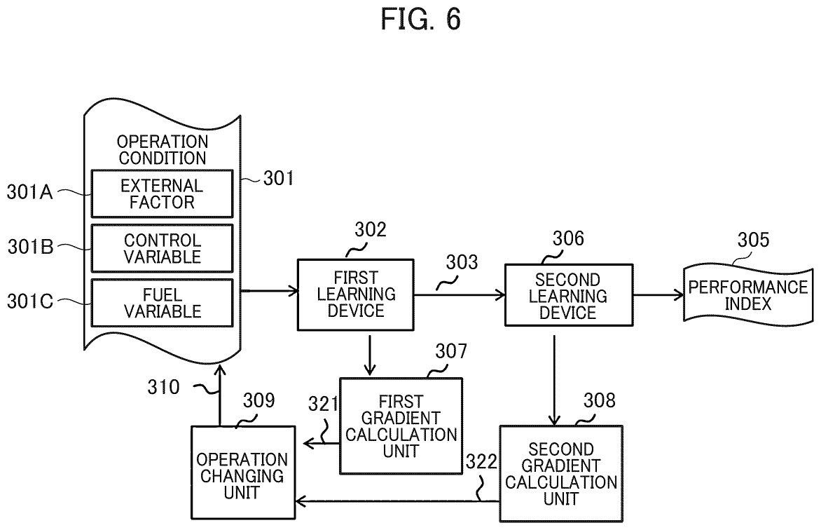

FIG. 6 is a functional configuration diagram of a computing device 800 according to a modification 1. The present diagram is different from FIG. 3 in the first embodiment in that a fuel variable 301C is added to the operation condition 301. The fuel variable 301C is, for example, the properties of fuel supplied to the internal combustion engine 1 such as viscosity and mass, information on the type of fuel, the time when the fuel was put into the fuel tank, the time when the fuel injection device is replaced, and the like. In the combustion of the internal combustion engine 1, the combustion form changes depending on the fuel to be used, and the amounts of PN, THC, and the like emitted also change. Further, since the fuel properties change depending on the deterioration state of the fuel, it is possible to respond to the case of refueling or a change in the type of fuel by including the state of the fuel in the operation condition 301.

According to the present modification 1, the following actions and effects can be obtained.

(5) The properties of the fuel fed to the internal combustion engine 1 is input to the first learning device 302. Therefore, the operation condition 301 corresponding to the properties of the fuel can be calculated.

(6) The type of fuel fed to the internal combustion engine 1 and the time when the fuel was fed to the fuel tank are input to the first learning device 302. Therefore, it is possible to calculate the operation condition 301 corresponding to more detailed fuel properties such as the type of fuel and the time to feed the fuel to the fuel tank.

### Modification 2

The calculation by the computing device 800 can be applied not only to the internal combustion engine 1 but also to various parts mounted on many vehicles 9. For example, it can also be applied to an electric motor as described below.

For example, in the electric motor, the current value applied to the electric motor corresponds to the operation condition 301, the generated magnetic flux and the interlinked magnetic flux to a core correspond to the physical quantity 303, and the torque, speed, and efficiency correspond to the performance index 305.

### Modification 3

In the first embodiment described above, the learning of the neural network included in each of the first learning device 302 and the second learning device 306 has been completed in advance. However, the first learning device 302 and the second learning device 306 may perform additional learning using measurable values in parallel with inference.

### Second Embodiment

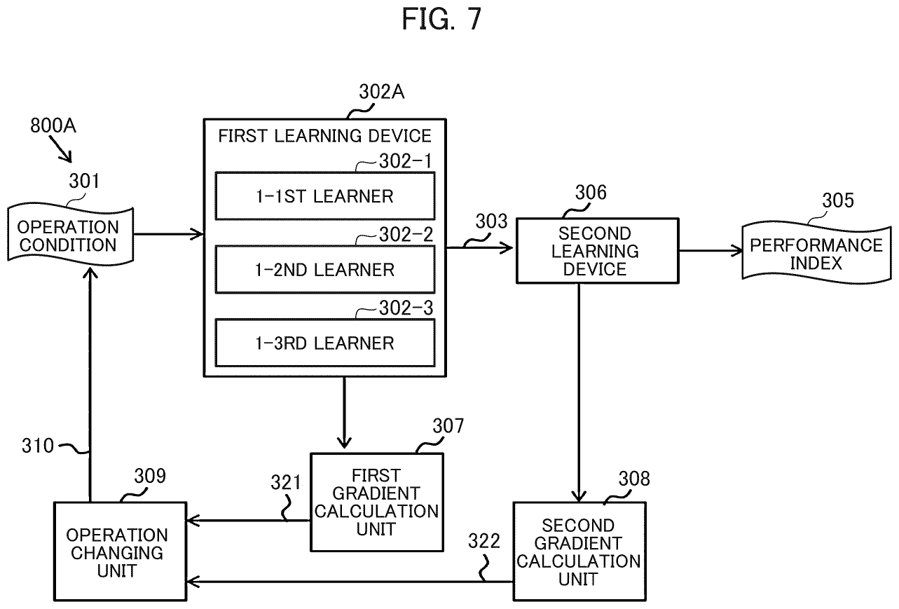

A second embodiment of an operation condition calculation system will be described with reference to FIG. 7. In the following description, the same components as those in the first embodiment are designated by the same reference numerals, and points of difference will be mainly described. Points which are not particularly described are the same as those in the first embodiment. The present embodiment is different from the first embodiment mainly in that the first learning device 302 is comprised of a plurality of learners.

FIG. 7 is a functional configuration diagram of a computing device 800A in the second embodiment. FIG. 7 is different from FIG. 3 in the first embodiment in that a first learning device 302A is provided instead of the first learning device 302. The first learning device 302A includes one or more learners which estimate only one specific physical quantity. FIG. 7 shows a case in which the first learning device 302A estimates three specific physical quantities. The first learning device 302A includes a 1-1st learner 302-1, a 1-2nd learner 302-2, and a 1-3rd learner 302-3. The neural networks which constitute the 1-1st learner 302-1, the 1-2nd learner 302-2, and the 1-3rd learner 302-3 each have only a node which indicates any specific physical quantity in the output layer.

The neural networks constituting each of the 1-1st learner 302-1, the 1-2nd learner 302-2, and the 1-3rd learner 302-3 may have different number of nodes in the input layer.

That is, each neural network may input only specific conditions which are highly related to the estimated specific physical quantity, or may input conditions excluding specific conditions which are weakly related to the specific physical quantity estimated from all specific conditions.

According to the above-described second embodiment, the following actions and effects can be obtained.

(7) The first learning device 302A has one machine learner for each specific physical quantity which is a specific physical quantity. All or part of the operation conditions are input to each of the 1-1st learner 302-1, the 1-2nd learner 302-2, etc. Therefore, the size of each neural network constituting the first learning device 302A can be reduced, and an improvement in the accuracy of an output result can be expected.

### Third Embodiment

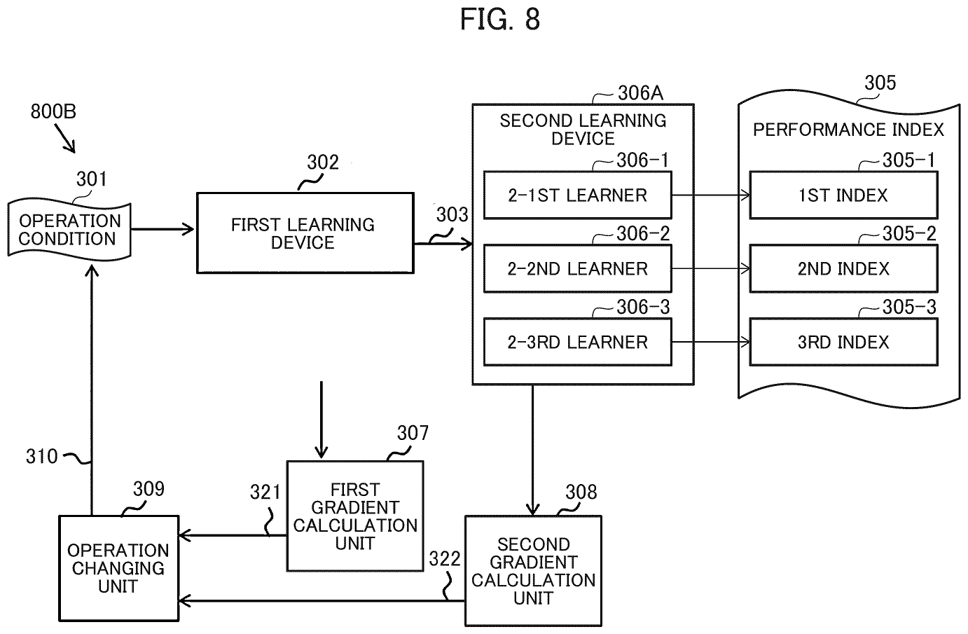

A third embodiment of an operation condition calculation system will be described with reference to FIG. 8. In the following description, the same components as those in the first embodiment are designated by the same reference numerals, and points of difference will be mainly described.

Points which are not particularly described are the same as those in the first embodiment. The present embodiment is different from the first embodiment mainly in that the second learning device 306 is comprised of a plurality of learners.

FIG. 8 is a functional configuration diagram of a computing device 800B in the third embodiment. The point of difference from FIG. 3 in the first embodiment is that a second learning device 306A is provided instead of the second learning device 306. The second learning device 306A includes one or more learners which estimate only one specific index.

FIG. 8 shows a case in which the second learning device 306A estimates three specific indexes. The second leaning device 306A includes a 2-1st learner 306-1, a 2-2nd learner 306-2, and a 2-3rd learner 306-3.

The neural networks which constitute the 2-1st learner 306-1, the 2-2nd learner 306-2, and the 2-3rd learner 306-3 each have only a node which indicates any specific index in the output layer. Specifically, the 2-1st learner 306-1, the 2-2nd learner 306-2, and the 2-3rd learner 306-3 output a first index 305-1, a second index 305-2, and a third index 305-3, respectively.

The neural networks constituting each of the 2-1st learner 306-1, the 2-2nd learner 306-2, and the 2-3rd learner 306-3 may have different number of nodes in the input layer.

That is, each neural network may input only specific physical quantities which are strongly related to the estimated specific index, or may input conditions excluding specific physical quantities which are weakly related to the specific index estimated from all specific conditions.

According to the above-described third embodiment, the following actions and effects can be obtained.

(8) The second learning device 306A has one machine learner for each performance index. All or part of the output of the first learning device 302 are input to each of the 2-1st learner 306-1, the 2-2nd learner 306-2, etc. Therefore, the size of each neural network constituting the second learning device 306A can be reduced, and an improvement in the accuracy of an output result can be expected.

### Fourth Embodiment

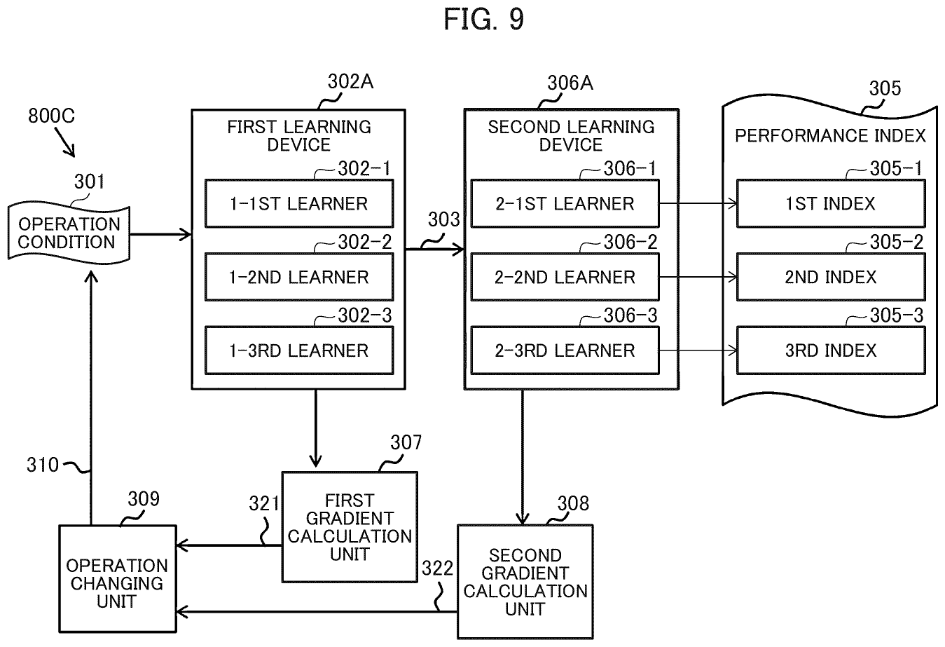

A fourth embodiment of an operation condition calculation system will be described with reference to FIG. 9. In the following description, the same components as those in the first embodiment are designated by the same reference numerals, and points of difference will be mainly described.

Points which are not particularly described are the same as those in the first embodiment. The present embodiment is different from the first embodiment in that the first learning device 302 and the second learning device 306 are each comprised of a plurality of learners.

FIG. 9 is a functional configuration diagram of a computing device 800C in the fourth embodiment. The point of difference from FIG. 3 in the first embodiment is that a first learning device 302A is provided instead of the first learning device 302, and a second learning device 306A is provided instead of the second learning device 306. The first learning device 302A is as described in the second embodiment, and the second learning device 306A is as described in the third embodiment.

The first learning device 302A includes one or more learners which estimate only one specific physical quantity.

FIG. 7 shows a case in which the first learning device 302A estimates three specific physical quantities. The first learning device 302A includes a 1-1st learner 302-1, a 1-2nd learner 302-2, and a 1-3rd learner 302-3. The neural networks which constitute the 1-1st learner 302-1, the 1-2nd learner 302-2, and the 1-3rd learner 302-3 each have only a node which indicates any specific physical quantity in the output layer.

### Fifth Embodiment

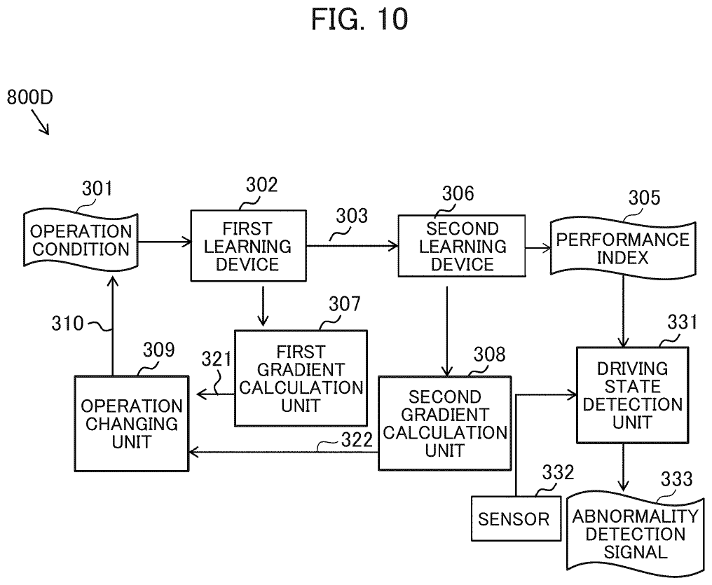

A fifth embodiment of an operation condition calculation system will be described with reference to FIG. 10. In the following description, the same components as those in the first embodiment are designated by the same reference numerals, and points of difference will be mainly described.

Points which are not particularly described are the same as those in the first embodiment. The present embodiment differs from the first embodiment mainly in that a driving state is detected.

FIG. 10 is a functional configuration diagram of a computing device 800D in the fifth embodiment. The point of difference from FIG. 3 in the first embodiment is that there are provided a driving state detection unit 331 and a sensor 332. The sensor 332 measures a value related to a performance index 305 of the vehicle in which the computing device 800D is mounted. The sensor 332 is, for example, a PM sensor or a THC measuring device. To the driving state detection unit 331, the measured value is input from the sensor 332 and the performance index 305 is input from the second learning device 306.

The performance index 305 is estimated based on the output of the sensor 332. The driving state detection unit 331 compares the estimated performance index 305 with the performance index 305 output by the second learning device 306, and outputs an abnormality detection signal 333 when there is a deviation between the two, which is a predetermined threshold or more. The abnormality detection signal 333 may be notified to the occupants of the vehicle 9, or may be read by an unillustrated device mounted on the vehicle 9. For example, when there is a deviation between the THC calculated by the driving state detection unit 331 and the THC calculated by the second learning device 306, there is considered a malfunction such as an increase in the amount of fuel attached due to abnormality in the fuel injection device or poor ignition due to wear of the ignition plug 105. That is, the present invention can be treated as an index for checking whether the internal combustion engine 1 is operating normally.

(9) The driving state detection unit 331 is provided which is capable of detecting the driving state of the internal combustion engine 1 from the output of the sensor 332 mounted on the vehicle 9 and the performance index calculated by the second learning device 306. Therefore, it is possible to easily determine whether the internal combustion engine 1 is operating normally.

### Sixth Embodiment

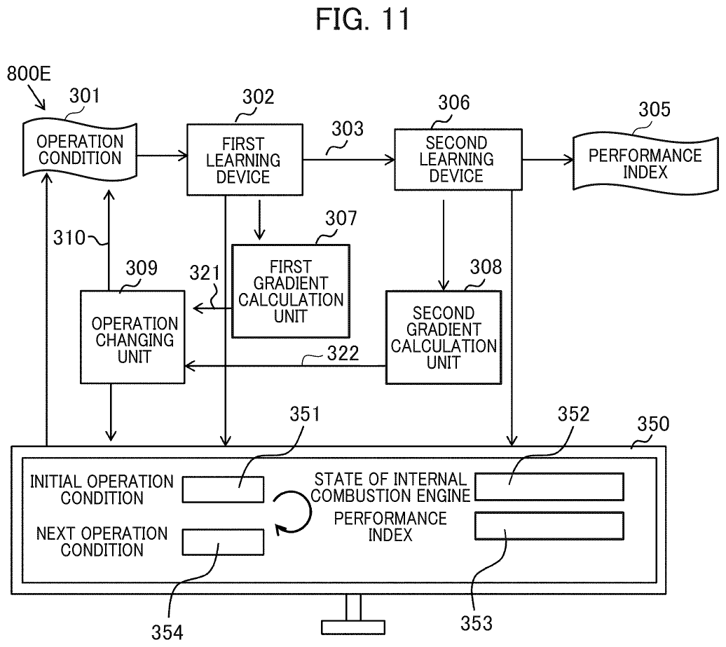

A sixth embodiment of an operation condition calculation system will be described with reference to FIG. 11. In the following description, the same components as those in the first embodiment are designated by the same reference numerals, and points of difference will be mainly described.

Points which are not particularly described are the same as those in the first embodiment. The present embodiment differs from the first embodiment mainly in that a display unit which displays calculation results is provided. Also, in the present embodiment, a computing device is not mounted on the vehicle.

FIG. 11 is a functional configuration diagram of a computing device 800E in the sixth embodiment. The point of difference between FIG. 11 and FIG. 3 in the first embodiment is that a user interface 350 is provided. The user interface 350 functions as an input unit and an output unit. The user interface 350 outputs calculation results of a first learning device 302, a second learning device 306, and an operation changing unit 309. The user interface 350 receives the input of an operation condition 301 by a user.

The user interface 350 has an initial operation condition input field 351, an internal combustion engine state display field 352, a performance index display field 353, and a next operation condition display field 354. The user inputs the operation condition 301 to the initial operation condition input field 351 using a mouse or a keyboard included in the input/output device 84. The value input into the initial operation condition input field 351 is input to the first learning device 302. The first learning device 302 in the present embodiment also outputs the calculated physical quantity 303 to the user interface 350, and the user interface 350 displays the physical quantity 303 in the internal combustion engine state display field 352.

The second learning device 306 in the present embodiment also outputs the calculated performance index 305 to the user interface 350, which displays the performance index 305 in the performance index display field 353. The operation changing unit 309 in the present embodiment also outputs the calculated new operation condition 310 to the user interface 350, which displays the new operation condition 310 in the next operation condition display field 354.

When the user inputs the operation condition 301, the results of estimation by the first learning device 302 and the second learning device 306 are displayed on the user interface 350. By confirming these, the user can determine whether or not to adopt the input operation condition. Further, when the user wants to further improve the performance index 305, the user may refer to the next operation condition display field 354.

According to the sixth embodiment described above, the following actions and effects can be obtained.

(10) The user interface 350 which functions as the input unit for inputting the operation condition 301, and the user interface 350 which also functions as the display unit for displaying the output of the first learning device 302, the output of the second learning device 306, and the output of the operation changing unit 309 are provided. Therefore, it is possible to easily calculate the appropriate operation condition 301.

In each of the above-described embodiments and modifications, the functional block configurations are merely examples. Several functional configurations shown as separate functional blocks may be integrally configured, or a configuration shown in a single functional block diagram may be divided into two or more functions. Further, some of the functions of each functional block may be configured to be provided by other functional blocks.

In the above-described embodiments and modifications, the program is stored in the ROM 82, but the program may be stored in an unillustrated non-volatile storage device. The computing device 800 may also be provided with an unillustrated input/output interface, and the program may be loaded from another device when necessary via the input/output interface and a medium available to the computing device 800. Here, the medium refers to, for example, a storage medium which is detachable from the input/output interface, or a communication medium, i.e., a network such as wired, wireless, and light, or a carrier wave or a digital signal which propagates through the network. Further, some or all of the functions realized by the program may be realized by a hardware circuit or an FPGA.

The above-described embodiments and modifications may be combined with each other. Although various embodiments and modifications have been described above, the present invention is not limited to these. Other aspects which are conceivable within the scope of the technical concept of the present invention are also included within the scope of the present invention.

### LIST OF REFERENCE SIGNS

1: Internal combustion engine
9: Vehicle
84: Input/output device
301: Operation condition
302: First learning device
303: Physical quantity
305: Performance index
306: Second learning device
307: First gradient calculation unit
308: Second gradient calculation unit
309: Operation changing unit
310: New operation condition
321: First gradient
322: Second gradient
331: Driving state detection unit
332: Sensor
350: User interface
800, 800A to 800E: Computing devices

1. An operation condition calculation system comprising:
a first learning device which inputs an operation condition of an on-vehicle device mounted on a vehicle and outputs a physical state which occurs when the on-vehicle device operates based on the operation condition;
a second learning device which inputs an output of the first learning device and outputs a performance index;
a gradient calculation unit which calculates gradients of the first learning device and the second learning device; and
an operation changing unit which changes the operation condition using the gradients.

2. The operation condition calculation system according to claim 1, wherein
the on-vehicle device is an internal combustion engine.

3. The operation condition calculation system according to claim 2, wherein
the performance index is at least one of an exhaust component from the internal combustion engine and a combustion fluctuation rate, and
the operation changing unit changes at least one of an injection time, an injection split ratio, fuel pressure, and an ignition timing at the time of split injection of fuel.

4. The operation condition calculation system according to claim 2, wherein
the first learning device inputs at least an engine speed, a load, intake pressure, an intake air temperature, a water temperature, fuel pressure, the number of fuel injections, a fuel injection timing, a split ratio, and an ignition time, and outputs an in-cylinder temperature, in-cylinder pressure, an amount of fuel adhered, and an amount of over-rich mixture at least at the ignition time.

5. The operation condition calculation system according to claim 2, wherein
the second learning device inputs at least the in-cylinder temperature, the in-cylinder pressure, the amount of fuel adhered, the amount of over-rich mixture, and some or all of the input to the first learning device immediately before ignition, and outputs at least exhaust components generated after combustion and a combustion fluctuation rate.

6. The operation condition calculation system according to claim 2, wherein
the first learning device has one machine learner for each physical quantity, and
all or some of the operation condition are input to each of the machine learners.

7. The operation condition calculation system according to claim 2, wherein
the second learning device has one machine learner for each performance index, and
all or some of the output of the first learning device are input to each of the machine learners.

8. The operation condition calculation system according to claim 4, wherein
the first learning device inputs properties of the fuel fed to the internal combustion engine.

9. The operation condition calculation system according to claim 4, wherein
the first learning device inputs the type of fuel fed to the internal combustion engine and the time when the fuel is fed to a fuel tank.

10. The operation condition calculation system according to claim 2, including:
a driving state detection unit which calculates the performance index using the output of a sensor mounted on the vehicle and detects an abnormality in the vehicle by comparing the performance index with the performance index calculated by the second learning device.

11. The operation condition calculation system according to claim 2, including:
an input unit which inputs the operation condition, and a display unit which displays the output of the first learning device, the output of the second learning device, and
the output of the operation changing unit.

12. The operation condition calculation system according to claim 2, wherein
the performance index is an index which indicates the state of components and devices of the vehicle, and
the operation condition is sensor information acquired from the sensor mounded on the vehicle.

13. A control device for an internal combustion engine equipped with the operation condition calculation system according to claim 2.

14. An adaptation device for an internal combustion engine equipped with the operation condition calculation system according to claim 2.
